(19) United States
(12) Patent Application Publication
(10) Pub. No.: US 2026/0359932 A1
(43) Pub. Date: Nov. 12, 2026

(54) LATENT SPACE DIFFUSION IMAGE SIGNAL PROCESSING FOR LOW-LIGHT HIGH-RESOLUTION IMAGES

(71) Applicant: Samsung Electronics Co., Ltd., Suwon-si (KR)

(72) Inventors: Devendra Kumar Jangid, Plano, TX (US); Pavan Chennagiri Madhusudanarao, Redmond, WA (US); John Seokjun Lee, Allen, TX (US); Hamid Rahim Sheikh, Allen, TX (US)

(21) Appl. No.: 19/201,389

(22) Filed: May 7, 2025

(51) Int. Cl. G06T 3/4015; G06T 3/4046; G06T 5/50; G06T 5/60; G06T 5/70

(52) U.S. Cl. CPC G06T 3/4015; G06T 3/4046; G06T 5/50; G06T 5/60; G06T 5/70; G06T 2207/20221

(57) ABSTRACT

A method includes obtaining, by at least one processing device of an electronic device, an image frame captured using at least one imaging sensor. The method also includes generating, by the at least one processing device, a linear low-light sensor output based on the image frame using Bayer filtering. The method further includes generating, by the at least one processing device, low-light latent features based on the linear low-light sensor output using an encoder. The method also includes generating, by the at least one processing device, high-quality latent features based on the low-light latent features using a conditional diffusion module. The conditional diffusion module includes a stable diffusion model operably coupled to a conditional network. In addition, the method includes decoding, by the at least one processing device, the high-quality latent features using a decoder to generate a high-quality latent linear image.

### TECHNICAL FIELD

This disclosure relates generally to image processing. More specifically, this disclosure relates to latent space diffusion image signal processing for low-light high-resolution images.

### BACKGROUND

Digital camera image sensors typically include a grid of photosensors (referred to as pixels) overlaid with a grid of corresponding single-color filters in a color space, such as red-green-blue (RGB) or cyan-magenta-yellow (CMY), so that each pixel receives light of a single color in the color space. The grid of filters, referred to as a color filter mosaic (CFM) or color filter array (CFA), is designed to have a repeating pattern of single-color filters so that a group of pixels in one repetition of the pattern contains each color in the color space. The raw output of such an image sensor thus contains only a single color in each pixel. To create an output image in which each pixel contains information from the full color space, data from multiple surrounding pixels is used to interpolate the missing colors at each pixel using an image processing function known as demosaicing.

### SUMMARY

This disclosure relates to latent space diffusion image signal processing for low-light high-resolution images.

In a first embodiment, a method includes obtaining, by at least one processing device of an electronic device, an image frame captured using at least one imaging sensor. The method also includes generating, by the at least one processing device, a linear low-light sensor output based on the image frame using Bayer filtering. The method further includes generating, by the at least one processing device, low-light latent features based on the linear low-light sensor output using an encoder. The method also includes generating, by the at least one processing device, high-quality latent features based on the low-light latent features using a stable diffusion model and a conditional network. In addition, the method includes decoding, by the at least one processing device, the high-quality latent features using a decoder to generate a high-quality latent linear image.

In a second embodiment, an electronic device includes at least one processing device configured to obtain an image frame. The at least one processing device is also configured to generate a linear low-light sensor output based on the image frame using Bayer filtering and generate low-light latent features based on the linear low-light sensor output using an encoder. The at least one processing device is further configured to generate high-quality latent features based on the low-light latent features using a stable diffusion model and a conditional network. In addition, the at least one processing device is configured to decode the high-quality latent features using a decoder to generate a high-quality latent linear image.

In a third embodiment, a non-transitory machine-readable medium contains instructions that when executed cause at least one processor of an electronic device to generate a linear low-light sensor output based on an image frame using Bayer filtering. The non-transitory machine-readable medium also contains instructions that when executed cause the at least one processor to generate low-light latent features based on the linear low-light sensor output using an encoder and generate high-quality latent features based on the low-light latent features using a stable diffusion model and a conditional network. In addition, the non-transitory machine-readable medium contains instructions that when executed cause the at least one processor to decode the high-quality latent features using a decoder to generate a high-quality latent linear image.

Any single one or any combination of the following features may be used with the first, second, or third embodiment. The high-quality latent features may be generated by generating a conditional network output based on the low-light latent features using the conditional network and providing the conditional network output and the low-light latent features to the stable diffusion model. The high-quality latent features may be generated by inputting noise to the stable diffusion model. The low-light latent features may be generated by inputting the linear low-light sensor output into convolutional layers of the encoder to extract local features and applying a max pooling operation to the local features to generate the low-light latent features. The high-quality latent features may be generated by generating a conditional network output based on each of a plurality of image patches using the conditional network and generating a diffusion model patch output based on each of the plurality of image patches, the conditional network output, and a noise patch in the stable diffusion model. The high-quality latent features may be generated by generating the high-quality latent features using a partial patch merging process on the diffusion model patch output. The diffusion model patch output may be generated by obtaining first consecutive patches from a first portion of the low-light latent features, second consecutive patches from a second portion of the low-light latent features, and third consecutive patches from an entirety of the low-light latent features; denoising the first consecutive patches, the second consecutive patches, and the third consecutive patches using the stable diffusion model and the conditional network to generate first denoised patches, second denoised patches, and third denoised patches, respectively; merging the first denoised patches; merging the second denoised patches; and merging the third denoised patches.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example network configuration including an electronic device according to this disclosure;

FIG. 2A illustrates an example image processing architecture for latent space diffusion image signal processing for low-light high-resolution images according to this disclosure;

FIG. 2B illustrates a portion of the example image processing architecture of FIG. 2A according to this disclosure;

FIG. 2C illustrates an example neural network of the image processing architecture of FIG. 2A according to this disclosure;

FIG. 3 illustrates another example image processing architecture for latent space diffusion image signal processing for low-light high-resolution images according to this disclosure;

FIGS. 4A-4C illustrate example image processing in the image processing architecture of FIG. 3 according to this disclosure;

FIG. 5 illustrates an example method for latent space diffusion image processing for low-light high-resolution images according to this disclosure; and

FIG. 6 illustrates example images with and without latent space diffusion image processing according to this disclosure.

### DETAILED DESCRIPTION

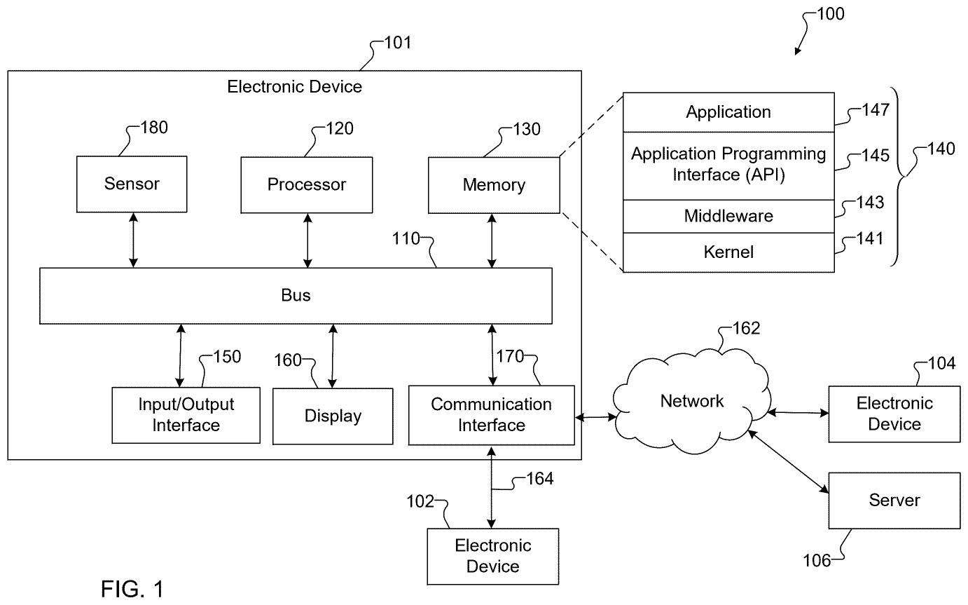

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As noted above, digital camera image sensors typically include a grid of photosensors (referred to as pixels) overlaid with a grid of corresponding single-color filters in a color space, such as red-green-blue (RGB) or cyan-magenta-yellow (CMY), so that each pixel receives light of a single color in the color space. The grid of filters, referred to as a color filter mosaic (CFM) or color filter array (CFA), is designed to have a repeating pattern of single-color filters so that a group of pixels in one repetition of the pattern contains each color in the color space. The raw output of such an image sensor thus contains only a single color in each pixel. To create an output image in which each pixel contains information from the full color space, data from multiple surrounding pixels is used to interpolate the missing colors at each pixel using an image processing function known as demosaicing.

Convolutional neural networks (CNNs) and transformer networks with supervised learning frameworks have been used for demosaicing tasks. However, these approaches are limited in learning textures and generating high-quality details, despite improvements in texture-based losses, feature-based losses, and generative adversarial network (GAN)-based losses. Among other reasons, this is because these additional losses can introduce artifacts and blur into images.

This disclosure provides techniques for latent space diffusion image signal processing for low-light high-resolution images. As described in more detail below, an image frame can be obtained, and a linear low-light sensor output can be generated based on the image frame using Bayer filtering. Low-light latent features can be generated based on the linear low-light sensor output using an encoder, and high-quality latent features can be generated based on the low-light latent features using a stable diffusion model and a conditional network. The high-quality latent features can be decoded using a decoder to generate a high-quality latent linear image.

In this way, the described techniques can be used to generate improved images of scenes, such as images having improved image quality. Note that while these techniques are often described below as being used for demosaicing, the same or similar techniques may be used to perform other image processing operations, such as super-resolution, denoising, and de-blurring.

FIG. 1 illustrates an example network configuration 100 including an electronic device according to this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to latent space diffusion image signal processing for low-light high-resolution images.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to latent space diffusion image signal processing for low-light high-resolution images. These functions can be performed by a single application or by multiple applications that each conduct one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high-definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving a separate network. The electronic device 101 can also be an augmented reality wearable device, such as eyeglasses, which include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to latent space diffusion image signal processing for low-light high-resolution images.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

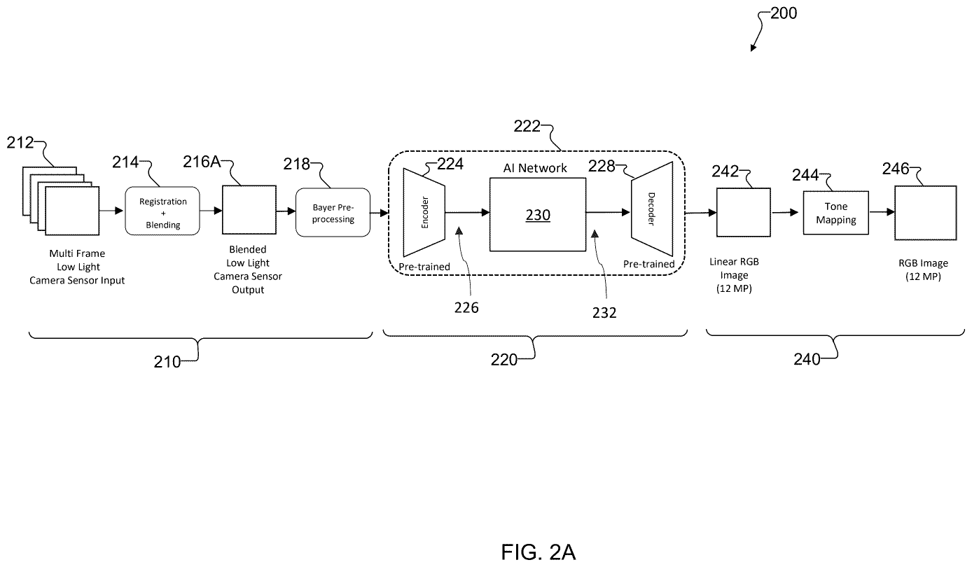

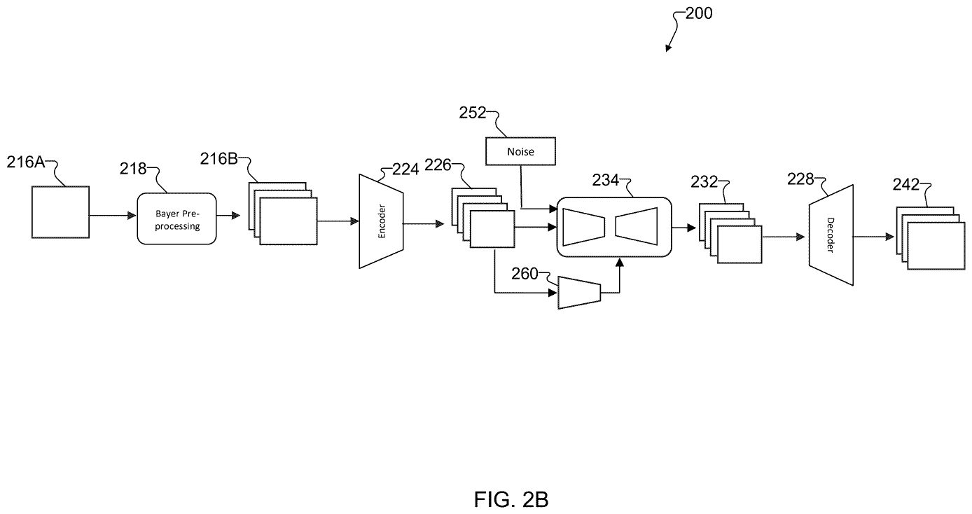

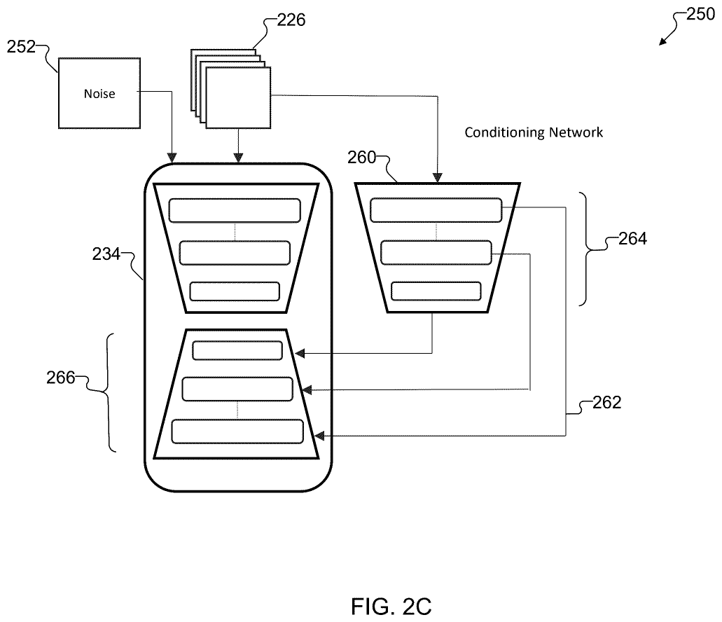

FIG. 2A illustrates an example image processing architecture 200 for latent space diffusion image signal processing for low-light high-resolution images according to this disclosure. For ease of explanation, the image processing architecture 200 is described as involving the use of the electronic device 101 in the network configuration 100 of FIG. 1. However, the image processing architecture 200 may be used with any other suitable device (such as the server 106) or a combination of devices (such as the electronic device 101 and the server 106) and in any other suitable system(s).

As shown in FIG. 2A, the image processing architecture 200 may be implemented in the electronic device 101, such as by using the processor 120. The image processing architecture 200 includes a pre-processing phase 210, a diffusion phase 220, and a post-processing phase 240. In the pre-processing phase 210, the image processing architecture 200 generally operates to receive image frames 212, such as multi-frame low-light image frames captured using at least one imaging sensor 180.

Each image frame 212 may optionally be input to a blending function 214 for registration and blending to produce a blended low-light sensor output 216A. In some cases, the blending function 214 may include both registration and blending techniques to align and merge image frames before further processing. For example, the blending function 214 may include feature-based registration that uses key points to align images, intensity-based registration that aligns images by minimizing intensity differences, optical flow-based registration that estimates pixel displacement between images, or a combination thereof. Additionally, the blending function 214 may include blending techniques, such as alpha blending that uses a weighted average to merge image frames, pyramid blending that uses multi-scale decomposition to blend image frames at different resolutions, gradient domain blending that adjust gradients of image frames to ensure smooth transitions, or a combination thereof. The resulting blended low-light sensor output 216A has improved accuracy in color representation and smoother transitions between pixels that subsequently improve the output of Bayer filtering.

The blended low-light sensor output 216A (or the image frame 212 in implementations without the blending function 214) is input into a Bayer pre-processing function 218 to apply Bayer filtering. Bayer filtering includes using a Bayer filter mosaic, such as a color filter array (CFA), placed over an image so that the CFA arranges red, green, and blue in a specific pattern (such as RGGB, BGGR, GBRG, or RGBG) to mimic human sensitivity to light. As such, the output of the Bayer pre-processing function 218 (such as a linear low-light sensor output 216B) includes pixels each having only one color, such as only red, green, or blue. Bayer filtering is done to enable a conditioning mechanism with stable diffusion. The Bayer pre-processing function 218 produces a linear low-light sensor output 216B for each image frame 212. The linear low-light sensor output 216B is a representation of each image frame 212 in the linear space and may include linear RGB values obtained from the at least one imaging sensor 180. The linear values of each of the R, G, and B color channels are directly proportional to an amount of light that illuminates the at least one imaging sensor 180 and facilitate pre-processing of raw image data for each image frame 212.

Each linear low-light sensor output 216B is passed into a neural network 222 of the diffusion phase 220. The neural network 222 may be configured, for example, as a U-Net neural network or other neural network architecture and may include an encoder 224, a conditional diffusion module 230, and a decoder 228. In this example, the linear low-light sensor output 216B is passed to the encoder 224 for encoding to generate low-light latent features 226, which are passed to the conditional diffusion module 230.

The encoder 224 may extract low-light latent features 226 from the linear low-light sensor output 216B by applying convolutional filters or layers (such as downsampling layers) to extract local features, which can include scanning regions of the linear low-light sensor output 216B to detect edges, textures, or other structures. After each convolution, an activation function, such as a rectified linear unit (ReLU) function, may introduce non-linearity to model complex variations in the linear low-light sensor output 216B. The encoder 224 may also include a max pooling operation to reduce spatial dimensions, such as by selecting the most dominant features within small regions of the linear low-light sensor output 216B. The encoder 224 can function to encode the linear low-light sensor output 216B into the latent space to generate the low-light latent features 226.

The conditional diffusion module 230 generates high-quality latent features 232 based on the low-light latent features 226. The high-quality latent features 232 are decoded in the decoder 228 before entering the post-processing phase 240. The decoder 228 may decode the high-quality latent features 232 by using a series of transposed convolutions (such as upsampling layers) to increase spatial resolution of the high-quality latent features 232 before applying convolutions to refine the high-quality latent features 232. Each decoder layer can receive a corresponding input from conditioning layers 264 of a conditioning network 260 (such as a conditioning network output) as part of feature spatial expansion, refinement, reconstruction in a sigmoid or other activation function, or a combination thereof as shown in FIG. 2B.

After reconstruction, the decoder 228 outputs a linear image 242, such as a high-quality linear RGB image. The linear image 242, similar to the linear low-light sensor output 216B, is a representation of a high-quality low-light image in the linear RGB space and may include linear RGB values that facilitate post-processing of image data. The linear image 242 may undergo tone mapping 244 to generate an RGB image 246. Tone mapping can be used to compress the dynamic range of the linear image 242 and may be used when the intensity values of the linear image 242 exceed a predetermined display capability of a device. Tone mapping 244 may include a dynamic range compression function, where the linear RGB values of the linear image 242 are adjusted to fit within predetermined brightness and contrast ranges before undergoing global tone mapping (such as applying a uniform transformation across the entire linear image 242) and local tone mapping (such as adjusting brightness and contrast based on surrounding pixels). The tone mapping 244 may also include gamma correction and exposure adjustments to match human vision and smooth transitions between shadows and highlights, respectively.

FIG. 2B illustrates a portion 250 of the example image processing architecture 200 of FIG. 2A according to this disclosure. In particular, the portion 250 is a close-up view of the conditional diffusion module 230 within the diffusion phase 220 of the image processing architecture 200. FIG. 2C illustrates an example neural network 222 of the image processing architecture 200 of FIG. 2A.

As shown in FIG. 2B, the conditional diffusion module 230 may include a stable diffusion model 234 operatively coupled to a conditioning network 260 such that the stable diffusion model 234 receives input from the conditioning network 260 as well as input from the encoder 224 directly. The stable diffusion model 234 may perform forward diffusion and reverse (backward) diffusion to incrementally add Gaussian noise to the low-light latent features 226 in order to iteratively predict cleaner versions of the low-light latent features 226. The conditioning network 260 can use the low-light latent features 226 to generate a conditional network output and to input the conditional network output into the stable diffusion model to produce the high-quality latent features 232. The conditioning network 260 is added to control pre-trained stable diffusion for demosaicing on linear low-light sensor output 216B from the Bayer pre-processing function 218, which may be preprocessed through bilinear interpolation or other interpolation technique for demosaicing the linear low-light sensor output 216B.

The encoder 224 is pre-trained to compress a pre-processed image, such as the linear low-light sensor output 216B, to a latent space. Similarly, the decoder 228 is pre-trained to decode high-quality latent features, such as the high-quality latent features 232, to a linear RGB image.

As shown in FIG. 2C, the neural network 222 may include the conditioning network 260 configured to generate a conditioning network output 262 having one or more conditioning layers 264 (such as one or more convolutional layers) whose output are input to decoder layers 266 of the stable diffusion model 234.

The conditioning network 260 may be a conditioning encoder pre-trained to receive condition information and output control signals. For example, the conditioning network 260 may use concatenation of a condition and a noisy latent as input of the encoder. The condition network 260 may also use parameters for a first convolution layer to initialize it to zero, functioning as a zero convolution, to avoid random noise as gradients. The conditioning network 260 outputs multi-scale features to modulate features within the stable diffusion model 234.

Although FIGS. 2A-2C illustrate one example of an image processing architecture 200 and related details, various changes may be made to FIGS. 2A-2C. For example, various components and functions in FIGS. 2A-2C may be combined, further subdivided, replicated, omitted, or rearranged according to particular needs. Also, one or more additional components and functions may be included if needed or desired. In addition, while images in a specific domain (namely the RGB domain) are described above, image data in any other suitable domain may be received and/or generated.

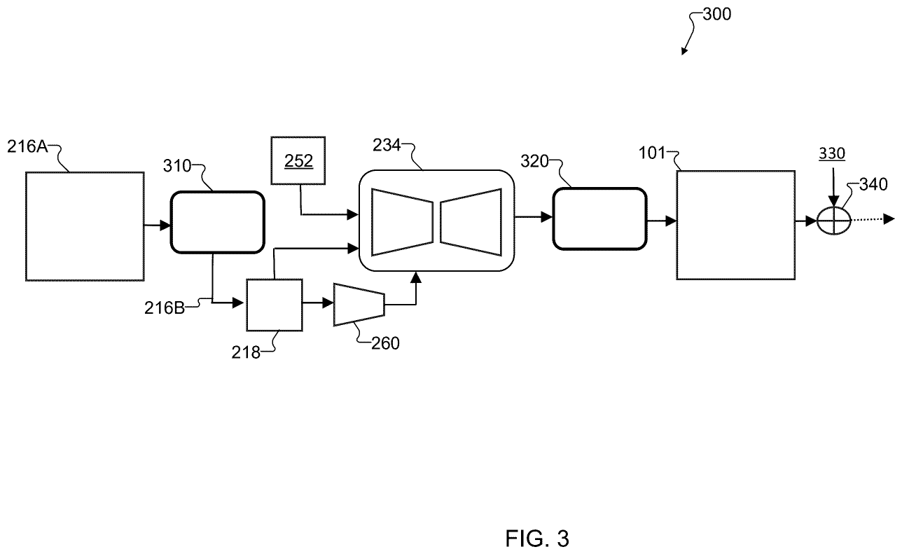

FIG. 3 illustrates another example image processing architecture 300 for latent space diffusion image signal processing for low-light high-resolution images according to this disclosure. In this example, the image processing architecture 300 is configured similarly to the image processing architecture 200 of FIGS. 2A-2C except as otherwise described.

As shown in FIG. 3, the image processing architecture 300 includes a partial patch splitting function 310 and a partial patch merging process 320 that occur on either side of the conditional diffusion model 230. For example, the blended low-light sensor output 216A (or the image frame 212 in implementations without a blending function 214) can be input into the partial patch splitting function 310.

The partial patch splitting function 310 divides the blended low-light sensor output 216A into smaller sections referred to as patches. The partial patch splitting function 310 may use any suitable technique(s) to divide the blended low-light sensor output 216A. For example, the partial patch splitting function 310 may include a patch splitting process where the blended low-light sensor output 216A is divided into small overlapping or non-overlapping patches using a specified stride and patch size. The partial patch splitting function 310 may include a sliding window approach where a fixed-size window moves across the blended low-light sensor output 216A and extracts patches at each step. The partial patch splitting function 310 may include grid-based splitting where the blended low-light sensor output 216A is divided into non-overlapping patches using a predefined grid. The partial patch splitting function 310 may include a random patch extraction process where patches are extracted randomly from different regions of the blended low-light sensor output 216A. The partial patch splitting function 310 may include an adaptive patch splitting process where the blended low-light sensor output 216A is divided based on content, such as edges or regions of interest to preserve important features while reducing unnecessary processing. Other or additional techniques or combinations of techniques may also be used here.

The partial patch splitting function 310 splits the blended low-light sensor output 216A and inputs one or more patches into the Bayer pre-processing function 218. The Bayer pre-processing function 218 outputs linear image patches to the stable diffusion model 234 and the conditioning network 260. The stable diffusion model 234 also receives noise input 252 (such as a Gaussian noise patch) to produce linear image patches.

The linear image patches are input into the partial patch merging process 320 for merging to produce the linear image 242. The partial patch merging process 320 may use any suitable technique(s) to merge the linear image patches. For example, the partial patch merging process 320 may include a weighted averaging merging process where overlapping linear image patches are merged by averaging their linear RGB values to maintain smooth color gradients. The partial patch merging process 320 may include using gradient-based techniques, including edge detection algorithms like Sobel or Canny, to identify sharp transitions between image patches in an edge-aware merging process to merge the linear image patches. The partial patch merging process 320 may include adaptive blending where the linear image patches are merged using weights based on local image characteristics, such as texture and intensity. Other or additional techniques (bilateral filtering and strided reconstruction) or combinations of techniques may also be used here. Additionally, the linear image 242 may receive a Gaussian noise input 330 in a combiner 340 (which may represent part of post-processing).

The image processing architecture 300 here supports a fast inter-step patch-splitting strategy to improve patch consistency issues that incorporates partial patch-splitting and merging. For example, the image processing architecture 300 uses the partial patch splitting function 310 and the partial patch merging process 320 to use partial patch splitting and partial patch merging on portions of an image before using full patch splitting and merging.

Although FIG. 3 illustrates another example of an image processing architecture 300, various changes may be made to FIG. 3. For example, various components and functions in FIG. 3 may be combined, further subdivided, replicated, omitted, or rearranged according to particular needs. Also, one or more additional components and functions may be included if needed or desired.

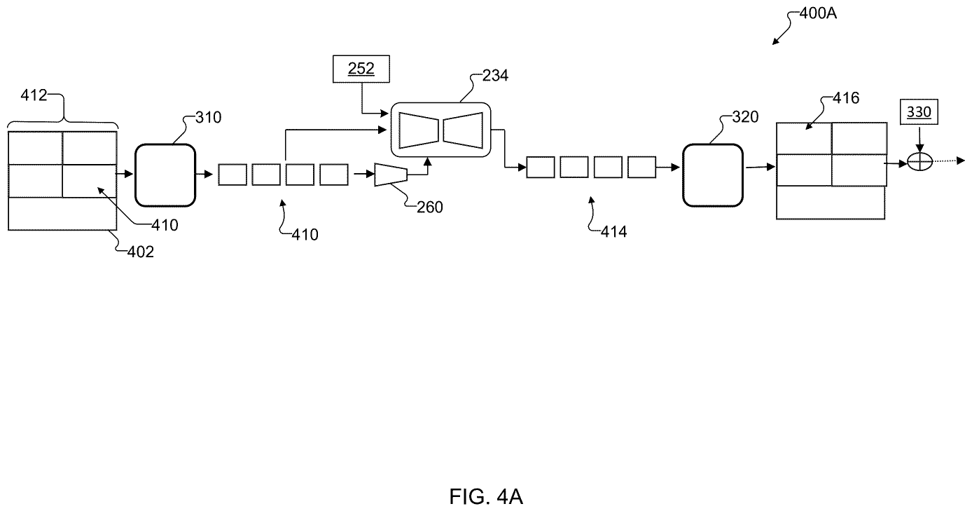

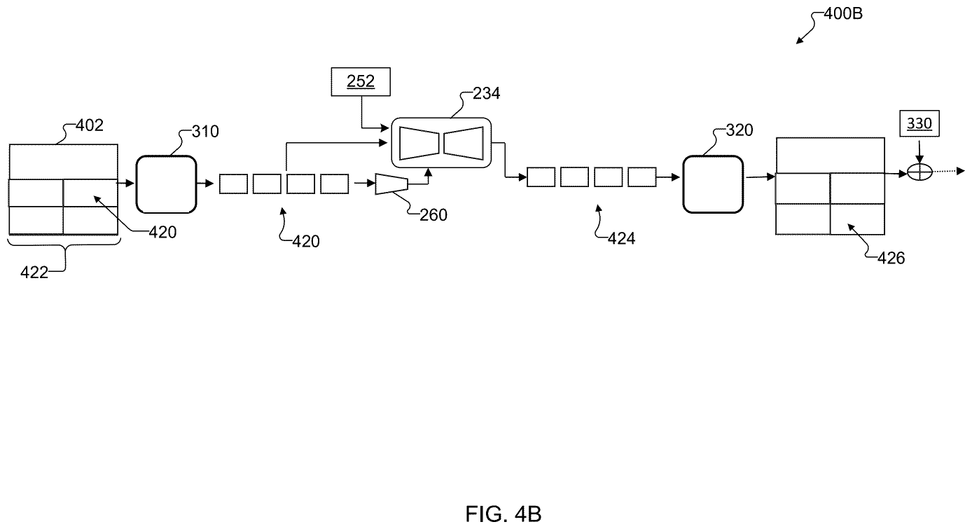

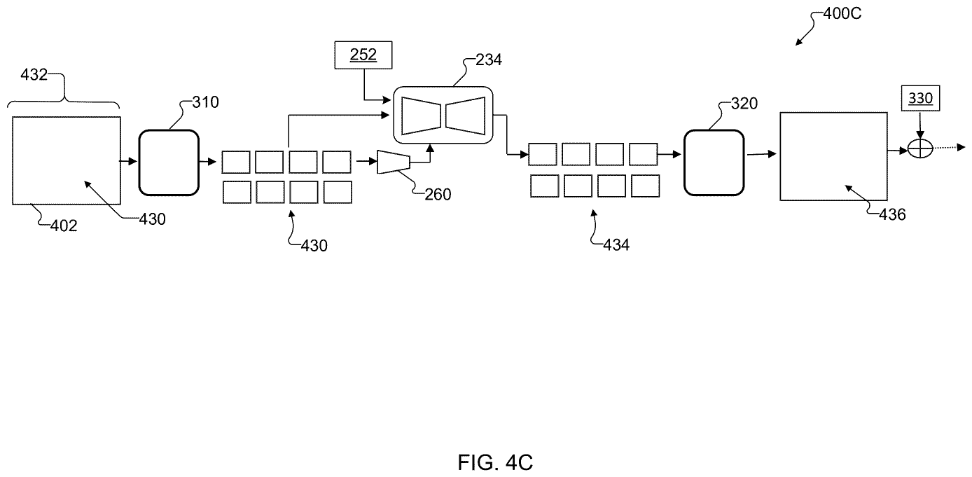

FIGS. 4A-4C illustrate example image processing in the image processing architecture 300 of FIG. 3 according to this disclosure. In particular, FIG. 4A illustrates an image 402 undergoing a first image processing step 400A, FIG. 4B illustrates the image 402 undergoing a second image processing step 400B, and FIG. 4C illustrates the image 402 undergoing a third image processing step 400C.

As shown in FIG. 4A, the partial patch splitting function 310 splits the image 402 into first consecutive patches 410 of a first portion 412 of the image 402. The first consecutive patches 410 may not be taken from the entirety of the image 402. For example, the first portion 412 may cover a fraction of the image 402, such as about one half. The first consecutive patches 410 are processed in the conditional diffusion model 230 to produce first denoised patches 414. The first denoised patches 414 are merged in the partial patch merging process 320 to produce first merged denoised patches 416 corresponding to the first portion 412 of the image 402. The first merged denoised patches 416 may be introduced to the Gaussian noise input 330 in the combiner 340.

As shown in FIG. 4B, the partial patch splitting function 310 splits the image 402 into second consecutive patches 420 of a second portion 422 of the image 402. The second consecutive patches 420 may not be taken from the entirety of the image 402. For example, the second portion 422 may cover a fraction of the image 402, such as about one half. The second consecutive patches 420 are processed in the conditional diffusion model 230 to produce second denoised patches 424. The second denoised patches 424 are merged in the partial patch merging process 320 to produce second merged denoised patches 426 corresponding to the second portion 422 of the image 402. The second merged denoised patches 426 may be introduced to the Gaussian noise input 330 in the combiner 340.

As shown in FIG. 4C, the partial patch splitting function 310 splits the image 402 into third consecutive patches 430 of a third portion 432 of the image 402. The third consecutive patches 430 may be taken from the entirety of the image 402. For example, the third portion 432 may cover a whole of the image 402. The third consecutive patches 430 are processed in the conditional diffusion model 230 to produce third denoised patches 434. The third denoised patches 434 are merged in the partial patch merging process 320 to produce third merged denoised patches 436 corresponding to the third portion 432 of the image 402. The third merged denoised patches 436 may be introduced to the Gaussian noise input 330 in the combiner 340. All patches (such as the first merged denoised patches 416, the second merged denoised patches 426, and the third merged denoised patches 436) can be merged together to form a diffusion model patch output (such as the linear image 242).

One example training technique for the diffusion model 234 may include randomly cropping patches from ground truth images, and Gaussian noise with random variances may be added to the ground truth patches. The stable diffusion model 234 can learn to predict the amount of noise added to the ground truth patches. A low-quality input image can also be conditioned on the U-Net architecture or other architecture using a conditioning mechanism.

Although FIGS. 4A-4C illustrate one example of image processing in the image processing architecture 300 of FIG. 3, various changes may be made to FIGS. 4A-4C. For example, various components and functions in FIGS. 4A-4C may be combined, further subdivided, replicated, omitted, or rearranged according to particular needs. Also, one or more additional components and functions may be included if needed or desired. In addition, the specific patches and groups of patches shown in FIGS. 4A-4C can vary depending on the implementation.

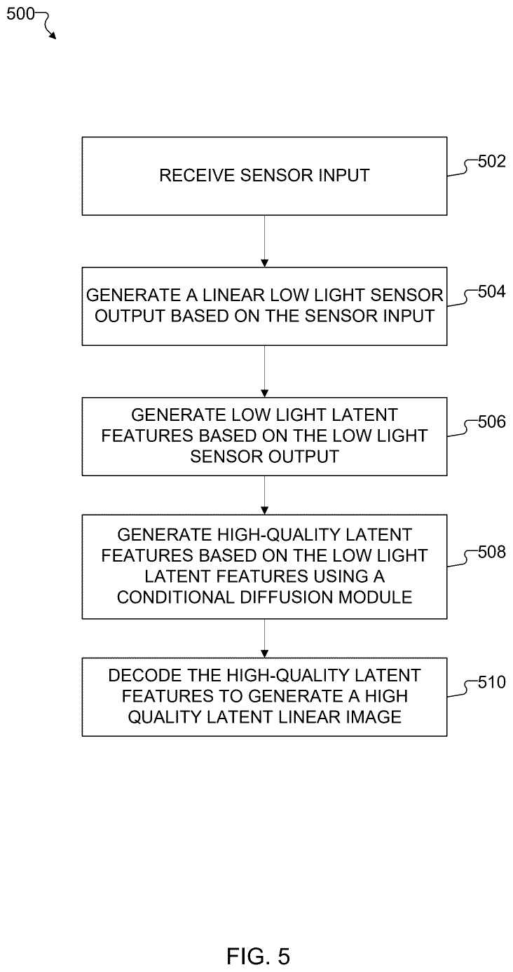

FIG. 5 illustrates an example method 500 for latent space diffusion image processing of low-light images according to this disclosure. For ease of explanation, the method 500 is described as involving the use of the electronic device 101 of FIG. 1 supporting the image processing architecture 200 of FIGS. 2A-2C or the image processing architecture 300 of FIG. 3. However, the method 500 may be used with any other suitable image processing architecture, and the method 500 may be used with any other suitable device (such as the server 106) or a combination of devices (such as the electronic device 101 and the server 106) and in any other suitable system(s).

As shown in FIG. 5, an image frame is obtained in step 502. For example, an image frame 212, such as a low-light image, may be obtained at the electronic device 101, such as when the image frame 212 is captured using one or more imaging sensors 180 of the electronic device 101. The image frame 212 may optionally undergo pre-processing, such as registration and/or blending.

A linear low-light sensor output is generated based on the image frame in step 504. For example, the Bayer pre-processing function 218 may use bilinear interpolation or other interpolation on the image frame 212 to generate the linear low-light sensor output 216B, such as a linear RGB image or other image.

Low-light latent features are generated based on the low-light sensor output using an encoder in step 506. For example, the linear low-light sensor output 216B may pass into the encoder 224 of the neural network 222. The encoder 224 may extract low-light latent features 226 from the linear low-light sensor output 216B by applying convolutional filters or layers (such as downsampling layers) to extract local features, which can include scanning regions of the linear low-light sensor output 216B to detect edges, textures, or other structures. After each convolution, an activation function, such as a rectified linear unit (ReLU) function, may introduce non-linearity to model complex variations in the linear low-light sensor output 216B. The encoder 224 may also include a max pooling operation to reduce spatial dimensions, such as by selecting the most dominant features within small regions of the linear low-light sensor output 216B. The encoder 224 can function to encode the linear low-light sensor output 216B into the latent space to generate the low-light latent features 226. In implementations with partial patch splitting and merging (such as in the image processing architecture 300), the low-light latent features 226 may be generated based on the linear low-light sensor output 216B using the encoder 224 by inputting the linear low-light sensor output 216B into the partial patch splitting function 310 to generate a plurality of image patches, such as the first consecutive patches 410, and passing the plurality of image patches into the encoder 224.

High-quality latent features are generated based on the low-light latent features using a conditional diffusion module in step 508. For example, the low-light latent features 226 can be input into the stable diffusion model 234 and the conditioning network 260. The stable diffusion model 234 may perform forward diffusion and reverse diffusion to incrementally add Gaussian noise to the low-light latent features 226 in order to iteratively predict cleaner versions of the low-light latent features 226. The conditioning network 260 can use the low-light latent features 226 to generate a conditional network output and to input the conditional network output into the stable diffusion model to produce the high-quality latent features 232. In some cases, generating the high-quality latent features may include inputting noise into the stable diffusion model to further refine the low-light latent features 226. In implementations with partial patch splitting and merging (such as in the image processing architecture 300), generating the high-quality latent features may include inputting each of the plurality of image patches (such as the first consecutive patches 410) into the stable diffusion model 234 and generating a conditional network output 262 based on each of the plurality of image patches using the conditional network 260. Here, the stable diffusion model 234 may generate high-quality latent features 232 using each of the plurality of image patches, the conditional network outputs 262, and the Gaussian noise input(s) 330.

The high-quality latent features are decoded using a decoder to generate a high-quality latent linear image in step 510. For example, the high-quality latent features 232 may be passed to the decoder 228 for decoding the high-quality latent features 232 by using a series of transposed convolutions (such as upsampling layers) to increase spatial resolution of the high-quality latent features 232 before applying convolutions to refine the high-quality latent features 232. Each decoder layer can receive a corresponding input from the conditioning layers 264 of the conditioning network 260 (such as the conditioning network output) as part of feature spatial expansion, refinement, reconstruction in a sigmoid or other activation function, or a combination thereof. After reconstruction, the decoder 228 outputs a linear image 242. In implementations with partial patch splitting and merging (such as in the image processing architecture 300), decoding the high-quality latent features 232 may include inputting the high-quality latent features 232 into a partial patch merging process 320 to generate the linear image 242. As such, first consecutive patches 410 may be taken from a first portion 412 of an image, the first consecutive patches 410 may be denoised using the stable diffusion model 234 and the conditioning network 260 to generate a first denoised patches 414, and the first denoised patches 414 may be merged to generate the first merged denoised patches 416. Similar operations may be taken to generate the second merged denoised patches 426 from the second consecutive patches 420 and the third merged denoised patches 436 from the third consecutive patches 430.

Although FIG. 5 illustrates one example of a method 500 for latent space diffusion image processing for low-light high-resolution images, various changes may be made to FIG. 5. For example, while shown as a series of steps, various steps in FIG. 5 may overlap, occur in parallel, occur in a different order, or occur any number of times (including zero times).

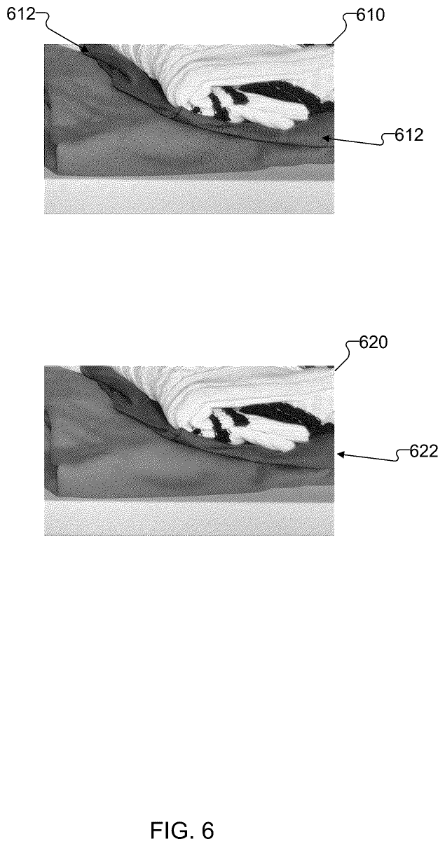

FIG. 6 illustrates example images with and without latent space diffusion image processing according to this disclosure. As shown in FIG. 6, a first image 610 represents an image of a scene generated using conventional demosaicing. As can be seen here, there is a color mismatch 612 (identified here as a difference in shading) within an object. For example, the object here represents clothing of a single color, but the first image 610 has multiple colors representing the color mismatch 612. In contrast, a second image 620 represents an image of the same scene generated using the techniques described above. As can be seen here, the techniques described above resolve the color mismatch 612 in an area 622. This indicates that there is improved color matching of objects within the second image 620 as compared to the first image 610.

Although FIG. 6 illustrates one example of images 620, 610 with and without latent space diffusion image processing, various changes may be made to FIG. 6. For example, FIG. 6 is merely meant to illustrate one example of a type of benefit that might be obtained using the techniques of this disclosure. The specific results that are obtained in any given situation can vary based on the circumstances and based on the specific implementation of the techniques described in this disclosure.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
obtaining, by at least one processing device of an electronic device, an image frame captured using at least one imaging sensor;
generating, by the at least one processing device, a linear low-light sensor output based on the image frame using Bayer filtering;
generating, by the at least one processing device, low-light latent features based on the linear low-light sensor output using an encoder;
generating, by the at least one processing device, high-quality latent features based on the low-light latent features using a stable diffusion model and a conditional network; and
decoding, by the at least one processing device, the high-quality latent features using a decoder to generate a high-quality latent linear image.

2. The method of claim 1, wherein generating the high-quality latent features comprises:
generating a conditional network output based on the low-light latent features using the conditional network; and
providing the conditional network output and the low-light latent features to the stable diffusion model.

3. The method of claim 2, wherein generating the high-quality latent features further comprises inputting noise to the stable diffusion model.

4. The method of claim 1, wherein generating the low-light latent features comprises:
inputting the linear low-light sensor output into convolutional layers of the encoder to extract local features; and
applying a max pooling operation to the local features to generate the low-light latent features.

5. The method of claim 4, wherein generating the high-quality latent features comprises:
generating a conditional network output based on each of a plurality of image patches using the conditional network; and
generating a diffusion model patch output based on each of the plurality of image patches, the conditional network output, and a noise patch in the stable diffusion model.

6. The method of claim 5, wherein generating the high-quality latent features comprises generating the high-quality latent features using a partial patch merging process on the diffusion model patch output.

7. The method of claim 5, wherein generating the diffusion model patch output comprises:
obtaining first consecutive patches from a first portion of the low-light latent features, second consecutive patches from a second portion of the low-light latent features, and third consecutive patches from an entirety of the low-light latent features;
denoising the first consecutive patches, the second consecutive patches, and the third consecutive patches using the stable diffusion model and the conditional network to generate first denoised patches, second denoised patches, and third denoised patches, respectively;
merging the first denoised patches;
merging the second denoised patches; and
merging the third denoised patches.

8. An electronic device comprising:
at least one processing device configured to:
obtain an image frame;
generate a low-light sensor output based on the image frame using Bayer filtering;
generate low-light latent features based on the low-light sensor output using an encoder;
generate high-quality latent features based on the low-light latent features using a stable diffusion model and a conditional network; and
decode the high-quality latent features using a decoder to generate a high-quality latent linear image.

9. The electronic device of claim 8, wherein, to generate the high-quality latent features, the at least one processing device is configured to:
generate a conditional network output based on the low-light latent features using the conditional network; and
provide the conditional network output and the low-light latent features to the stable diffusion model.

10. The electronic device of claim 9, wherein, to generate the high-quality latent features, the at least one processing device is further configured to input noise into the stable diffusion model.

11. The electronic device of claim 8, wherein, to generate the low-light latent features, the at least one processing device is configured to:
input the linear low-light sensor output into convolutional layers of the encoder to extract local features; and
apply a max pooling operation to the local features to generate the low-light latent features.

12. The electronic device of claim 11, wherein, to generate the high-quality latent features, the at least one processing device is configured to:
generate a conditional network output based on each of a plurality of image patches using the conditional network; and
generate a diffusion model patch output based on each of the plurality of image patches, the conditional network output, and a noise patch in the stable diffusion model.

13. The electronic device of claim 12, wherein, to generate the high-quality latent features, the at least one processing device is further configured to generate the high-quality latent features using a partial patch merging process on the diffusion model patch output.

14. The electronic device of claim 12, wherein, to generate the diffusion model patch output, the at least one processing device is configured to:
obtain first consecutive patches from a first portion of the low-light latent features, second consecutive patches from a second portion of the low-light latent features, and third consecutive patches from an entirety of the low-light latent features;
denoise the first consecutive patches, the second consecutive patches, and the third consecutive patches using the stable diffusion model and the conditional network to generate first denoised patches, second denoised patches, and third denoised patches, respectively;
merge the first denoised patches;
merge the second denoised patches; and
merge the third denoised patches.

15. A non-transitory machine-readable medium containing instructions that when executed cause at least one processor of an electronic device to:
generate a linear low-light sensor output based on an image frame using Bayer filtering;
generate low-light latent features based on the linear low-light sensor output using an encoder;
generate high-quality latent features based on the low-light latent features using a stable diffusion model and a conditional network; and
decode the high-quality latent features using a decoder to generate a high-quality latent linear image.

16. The non-transitory machine-readable medium of claim 15, wherein the instructions that when executed cause the at least one processor to generate the high-quality latent features comprise:
instructions that when executed cause the at least one processor to:
generate a conditional network output based on the low-light latent features using the conditional network; and
provide the conditional network output and the low-light latent features to the stable diffusion model.

17. The non-transitory machine-readable medium of claim 16, wherein the instructions that when executed cause the at least one processor to generate the high-quality latent features further comprise:
instructions that when executed cause the at least one processor to input noise into the stable diffusion model.

18. The non-transitory machine-readable medium of claim 15, wherein the instructions that when executed cause the at least one processor to generate the low-light latent features comprise:
instructions that when executed cause the at least one processor to:
input the linear low-light sensor output into convolutional layers of the encoder to extract local features; and
apply a max pooling operation to the local features to generate the low-light latent features.

19. The non-transitory machine-readable medium of claim 18, wherein the instructions that when executed cause the at least one processor to generate the high-quality latent features comprise:
instructions that when executed cause the at least one processor to:
generate a conditional network output based on each of a plurality of image patches using the conditional network; and
generate a diffusion model patch output based on each of the plurality of image patches, the conditional network output, and a noise patch in the stable diffusion model.

20. The non-transitory machine-readable medium of claim 19, wherein the instructions that when executed cause the at least one processor to generate the high-quality latent features further comprise:
instructions that when executed cause the at least one processor to generate the high-quality latent features using a partial patch merging process on the diffusion model patch output.
